(19) United States
(12) Patent Application Publication
(10) Pub. No.: US 2015/0321734 A1
(43) Pub. Date: Nov. 12, 2015

(54) HYBRID GIMBAL SUPPORT STRUCTURE

(71) Applicant: Single Buoy Morings Inc., Marly (CH)

(72) Inventors: Wilhelmus Coenradus Johannes Jozephus WOLDRING, Rotterdam (NL); Jack POLLACK, Camarillo, CA (US); David RIGGS, Coppell, TX (US)

(73) Assignee: Single Buoy Moorings, Inc., Marly (CH)

(21) Appl. No.: 14/651,704

(22) PCT Filed: Dec. 4, 2013
(86) PCT No.: PCT/NL2013/050871

§ 371 Date: Jun. 12, 2015

(30) Foreign Application Priority Data
Dec. 12, 2012 (EP) 12196621.2

(51) Int. Cl. B63B 27/30; F16L 1/20; B63B 35/03

(52) U.S. Cl. CPC B63B 27/30; B63B 35/03; F16L 1/205; B63B 2734/00

(57) ABSTRACT

A floating structure includes a hull and a work structure for supporting, lifting or lowering elongate objects. The work structure includes an elevating platform having an opening for receiving an object to be supported, lifted or lowered. The elevating platform is supported on the hull and is connected to a movable force element. The work structure includes a compensator platform pivotably supported on the hull around a pivot axis via a bracket or curved track. The compensator platform has an opening for receiving the object to be handled while the elevating platform is supported on the compensator platform via at least one elastomeric support. The force element is on one side attached to the hull and on the other side to the compensator platform for transmitting a driving force or a damping force to the platform when the platform is pivoted about a pin or displaced over the curved track.

### FIELD OF THE INVENTION

The invention relates to a floating structure comprising hull and a work structure for supporting, lifting or lowering elongate objects, the work structure comprising an elevating platform having an opening for receiving an object to be lifted, the elevating platform being supported on the hull and connected to a movable force element.

Such a structure is known from U.S. Pat. No. 6,213,686 disclosing a pipe-lay vessel having a J-lay tower, a working platform supporting a mast and an erector for placing pipe segments in a substantially vertical assembly position along the mast. The working platform can be moved relative to the hull via four vertically arranged hydraulic cylinders for adjusting the angle of the mast and erector relative to the pipe string that is laid on the sea bed.

US 2010/0119307 in the name of the applicant discloses a J laying tower mounted on a an outer and an inner gimbal table, each table being supported by a pair of pivot supports to be pivotable around two mutually perpendicular axes.

EP 2 201 280 discloses a pipe lying vessel with a work platform suported on vertically arranged hydraulic cylinders, a pipe clamping support being provided with a spherical elastomeric bearing.

For performing various operations on the seabed in deep water up to several kilometers depth, for instance maintenance or assembly and disassembly of electrical submersible pumps, subsea hydrocarbon processing equipment or other subsea structures, heavy elongate structures such as pipe strings or caissons need to be stably supported from the work over vessel. Instead of using vessels having relatively complex drilling and work over rigs, recent development of rigless intervention systems are of lighter weight and of simplified construction to provide more cost-effective intervention.

It is an object of the present invention to provide a work structure suitable for rigless intervention in offshore conditions that can stably support an elongate structure under various sea states. It is also an object of the invention to provide a work structure that is suitable for providing reliable static and dynamic positioning of the supported object.

### SUMMARY OF THE INVENTION

Hereto the compensator member of a floating structure according to the invention comprises a compensator platform pivotally supported on the hull around at least one pivot axis, the compensator platform comprising an opening for receiving the object to be lifted, the elevating platform being supported on the compensator platform via at least one elastomeric support, the force element being on one side attached to the hull and on the other side to the compensator platform for transmitting a driving force or a damping force to the platform when the platform is pivoted around the axis.

The elastomeric supports compensate small dynamic excursions of the work platform when the floating structure is subject to roll and pitch movements, for instance at angular excursions below 10 degrees, preferably below 5 degrees, while the compensator platform remains stationary. For larger excursions, for instance roll excursions of up to 20 degrees, the compensator platform can perform a pivoting movement relative to the hull around the pivot axis, in addition to the compensation provided by the elastomeric supports. These dynamic movements of the compensator platform can be damped by the force element. It is also possible to actively drive the compensator platform by the force element for static positioning of the compensator platform, also at flat sea states, for instance to adjust the angle of the elongate object to be lifted which may be required during pipe laying operations.

The work structure according to the invention can cooperate with a mast and a crane on the floating structure and may support the object to be lifted by supporting it off the elevating platform. Alternatively, the elevating platform may be provided with a clamping device to engage with the structure to be lifted, such as on the flanges of a subsea pipeline.

The threshold for the forces on the force element at which the compensator platform is active may be set relatively high, such that during regular conditions only the elastomeric supports are operational, while the force elements maintain the compensator platform in a stationary mid position. Only for larger excursions, the force member allows the compensator platform to move relative to the deck of the vessel about the pivot axis.

In one embodiment, the compensator platform is supported on the hull via at least one curved track that is displaceable relative to the hull by performing a rocking movement along the deck. By providing the curved tracks, a compact constroction is achieved in which the need for verically arranged force elements is obviated.

In a preferred embodiment, the work structure comprises a locking mechanism for locking the position of the compensator platform with regard to the roll axis relative to the hull. The locking mechanism may lock the position of the compensator platform for instance during standby or storage conditions. The locking mechanism may for instance comprise a pin or a friction brake on the hull, movable by an actuator to mechanically engage with the compensator platform. Alternatively, or in addition, in case the force element is formed by one or more hydraulic cylinders, the locking mechanism could operate to block hydraulic fluid flow into and out of the cylinders.

In one embodiment, the compensator member comprises at least two spaced apart wheel elements that are placed on the hull, opposite ends of the curved track of the compensator member engaging with the wheel elements. The wheels may be formed by bogie wheels with large load support capacity, such as for instance 1000 kN or more, and allow a rolling movement of the compensator platform along the wheels. Preferably, two spaced-apart curved tracks are provided each supported on the hull via at least two wheel elements for stable positioning of the compensator platform. The wheel elements may each comprise a set of at least two wheels.

For compensation of smaller excursions, at least three elastomeric support members may be arranged around the opening of the elevating platform. The elastomeric supports may be composite supports made of multilayered structures of resilient elastomeric material and metal reinforcement plates. The elastomeric supports preferably are of a generally cylindrical shape. The center lines of the elastomeric supports are positioned in an inclined angle of approximately 45 degrees in such a way that they point to the same center with a radius of approximately 2.2 m. In this way, the elastomeric support arrangement acts as a spherical bearing with a radius of 2.2 m. Rotation of this arrangement results in shear forces acting on the elastomeric bearings. In the shear force direction, these laminated elastomeric bearings are very flexible and large angles can be obtained with this “spherical bearing arrangement” such as rotations angles of 5 degrees or more.

The force element may comprise at least two substantially horizontally arranged cylinders engaging with one end on a driving flange on the compensator platform. A simple locking mechanism comprises a movable pin that can be engaged with the driving flange.

The cylinders may each comprise a piston, and on each side of the piston a piston rod extending in the cylinder, a bypass duct connecting each side of the cylinder via a relieve valve. As the internal volumes of the cylinder on each side of the piston are equal, a damping effect is obtained in a simple manner when fluid is displaced from one side of the cylinder to the other via the relieve valve. The damping effect can be adjusted by opening and closing of the valve, wherein the cylinder is locked by closing of the valve.

The work structure according to the invention may be utilized over a moon pool in the hull of the floating structure, may be utilized at the bow or at the stern or may project in a cantilevered manner beyond a side of the hull. It can be used for handling i.e. lowering and lifting but also supporting of elongates objects which may be formed e.g.

by Steel Catenary Risers (SCRs) or Cold water intake pipes, etc.. The support of elongate objects has to be understood as including the hang-off (temporary or not) of such object.

### BRIEF DESCRIPTION OF THE DRAWINGS

An embodiment of a floating structure according to the invention will, by way of non-limiting example, be described in detail with reference to the accompanying drawings.

In the drawings:

FIG. 1 shows a schematic longitudinal side view of a floating structure comprising a work structure according to the invention,

FIGS. 2 and 3 show schematic transverse views of floating structure comprising a work structure placed over a moonpool and in a cantilevered side position, respectively,

FIG. 4 shows a schematic longitudinal view of floating structure without a vertical mast or tower,

FIG. 5 shows a detailed perspective view of a work structure according to the present invention,

FIG. 6 shows a top view of the work structure of FIG. 5,

FIG. 7 shows a schematic layout of the hydraulic cylinders of the work structure of FIGS. 6 and 7, and

FIG. 8 shows an alternative embodiment of a work structure, the compensator platform being suspended from a pivot support.

### DETAILED DESCRIPTION OF THE INVENTION

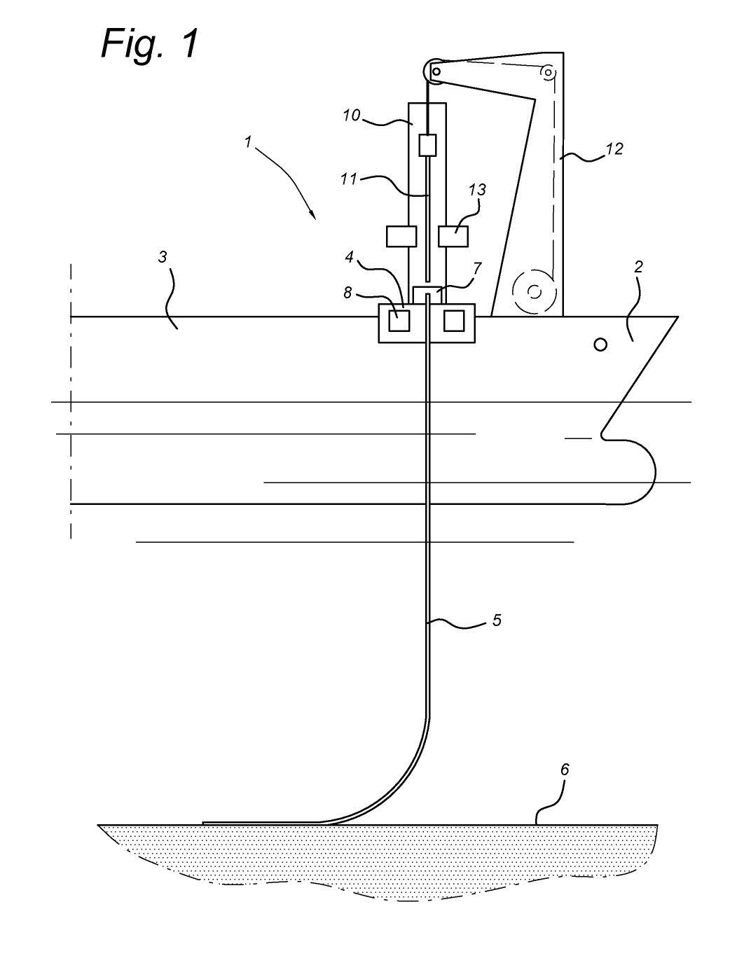

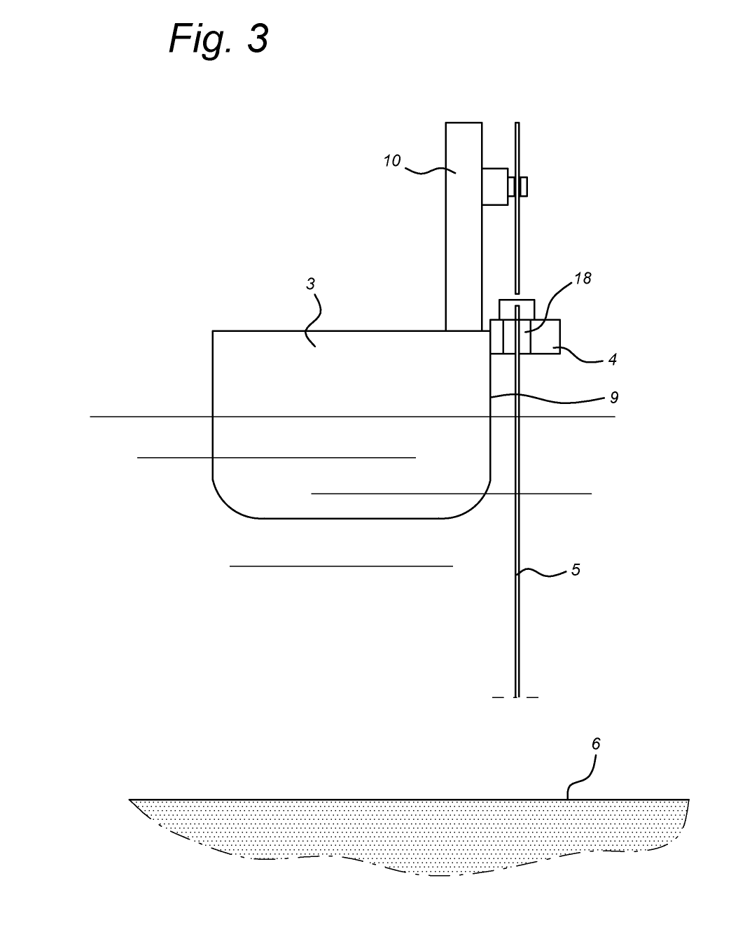

FIG. 1 shows a floating structure 1, such as a work-over vessel or pipe-laying vessel 2 having a hull 3 and carrying a work structure 4. The work structure 4 comprises an opening through which an elongate object passes, such as a pipeline 5 that extends upward from the seabed 6. An upper end 7 of the pipeline may, for instance via a broadened flange, be supported on the work structure 4. Alternatively, the work structure may be provided with a clamping device 8 for engaging with the pipeline 5. A vertical mast or tower 10 is provided, onto which pipe sections 11 may be loaded by a crane 12, or via loader arm, for connection to the pipeline 5 and subsequent lowering to the seabed 6. The tower 10 may be provided with a support device 13 that may be raised and lowered along the tower 10. In an alternative embodiment, the tower 10 is omitted, only the crane 12 being provided for lifting the elongate object from the seabed, such as shown in FIG. 4.

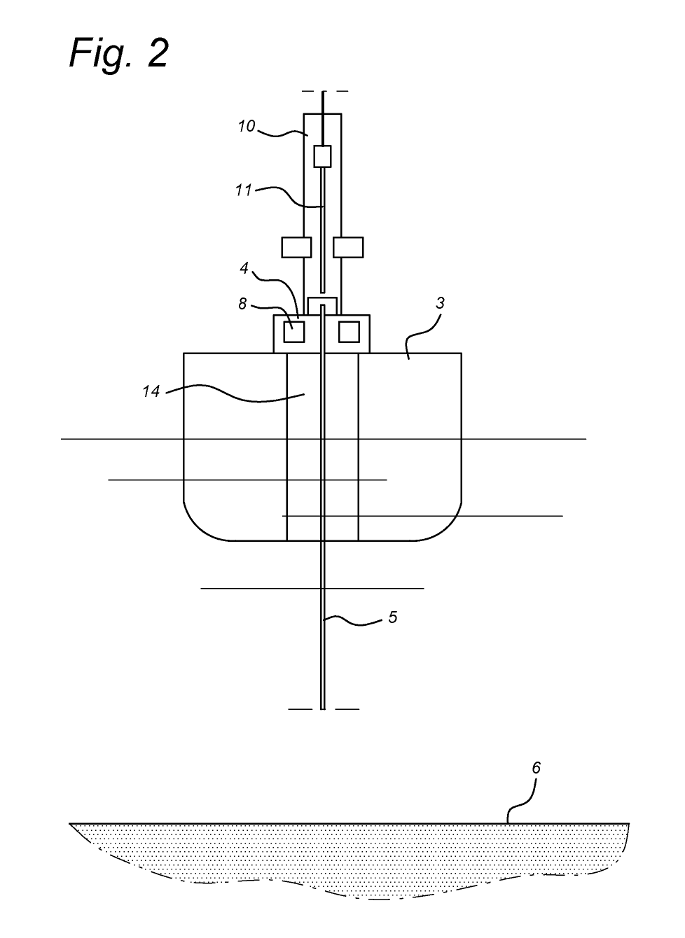

FIG. 2 shows an embodiment in which the work structure 4 is placed at a central position of the hull 3, on a deck over a cylindrical column, or moonpool 14, extending vertically through the hull 3. FIG. 3 shows an embodiment in which work structure 4 is provided outboard of the hull 3 in a cantilevered position at a side 9 of the hull 3.

FIG. 4 shows an embodiment in which no tower 10 is provided for erecting and coupling of pipe segments, but in which the work structure 4 is designed for rigless intervention on a caisson 16 containing for instance electrical submersible pumps, that is attached to an equipment module 17 that has been lifted from the sea bed via the crane 12 and that is supported on the work structure, over the opening 18.

The work structure 4 shown in FIGS. 1-4 can accommodate roll movements of the vessel around its longitudinal axis 20 and pitch movements around the pitch axis that extends perpendicular to the plane of the drawing, by being movably supported on the hull 3 via an elastomeric support and a rolling support arrangement, and comprises an elevating platform that can tilt about the roll and pitch axes.

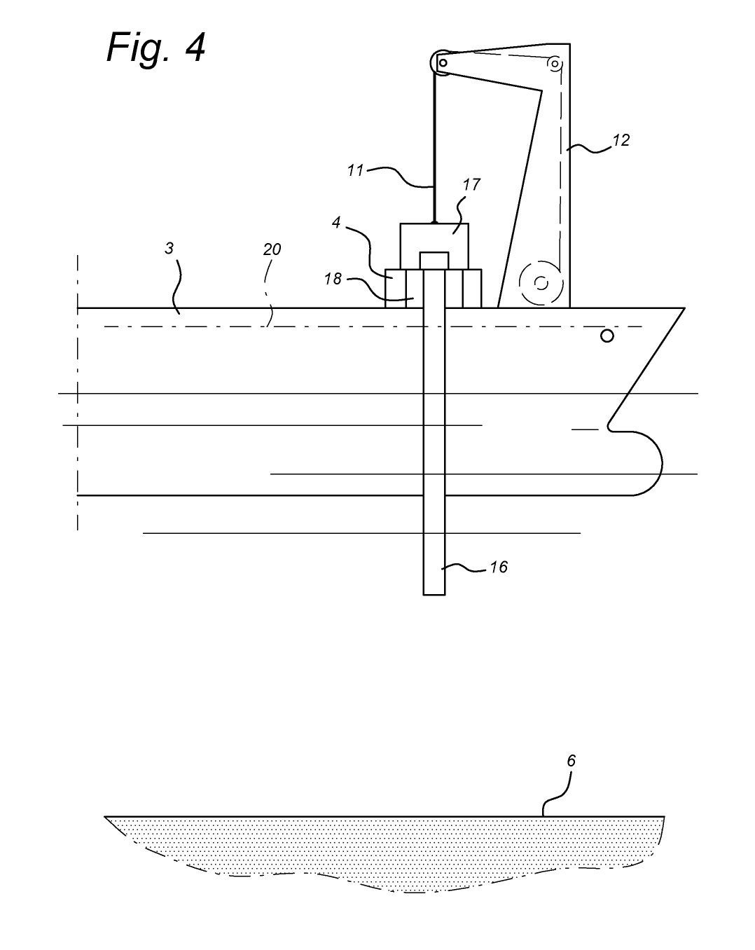

FIG. 5 shows the work structure 4 according to the invention, comprising the elevating platform 25 and compensator platform 26. The elevating platform 25 comprises an opening 24 through which an object to be lifted can pass, via a slit 27 extending from the opening 24 to the side of the platform 25. The elevating platform 25 is supported on the compensator platform 26 via five elastomeric supports 28, 29. The compensator platform 26 is at is lower side of rounded shape and comprises two curved tracks 30, 31 that are supported on sets of bogie wheels 32,33 mounted on the deck 34.

The compensator platform 26 is connected to two hydraulic cylinders 35, 36 that are with one end 37 attached to the deck 34 and with another end 38 to a flange 40 on the compensator platform 26. A locking pin 41 is movably mounted in a flange 42 near the side of the platform 26.

The elevating platform 25 can tilt, for instance by 5 degrees on the elastomeric supports 28, 29 around the roll axis 20 and around the pitch axis 21. During these relatively small dynamic excursions, the pistons of the cylinders 35, 36 do not move and maintain the compensator platform 26 in a central equilibrium position. For larger excursions around the roll axis 20, the cylinders 35, 36 allow a damped movement of the curved tracks 30, 31 along the bogie wheels 32, 33 of about 11 degrees so that in total excursions around the roll axis 20 of 16 degrees can be accommodated. During movement of the curved tracks 30,31 along the bogie wheels 32,33, the compensator platform 26 pivots relative to the deck of the vessel about pivot axis 60 that extends perpendicular to the plane of the drawing, the pivot axis 60 being is situated at a distance above the elevating platform 25.

The elastomeric supports 28, 29 are of generally cylindrical shape and have axes 43 that are inclined towards the opening 45 in the compensator platform 26 and that are at an angle a of about 40-60 degrees with the surface of the platform 26. The supports 28, 29 are made up of laminated stacks 46 of metal and elastomeric discs encased between upper and lower cylindrical support parts 47, 48. The five inclined elastomeric supports provide sufficient redundancy in case a support needs to be replaced, while minimizing the length of the moment arm. This reduces the total compensating moment while also reducing the spherical shear displacement in the elastomeric discs.

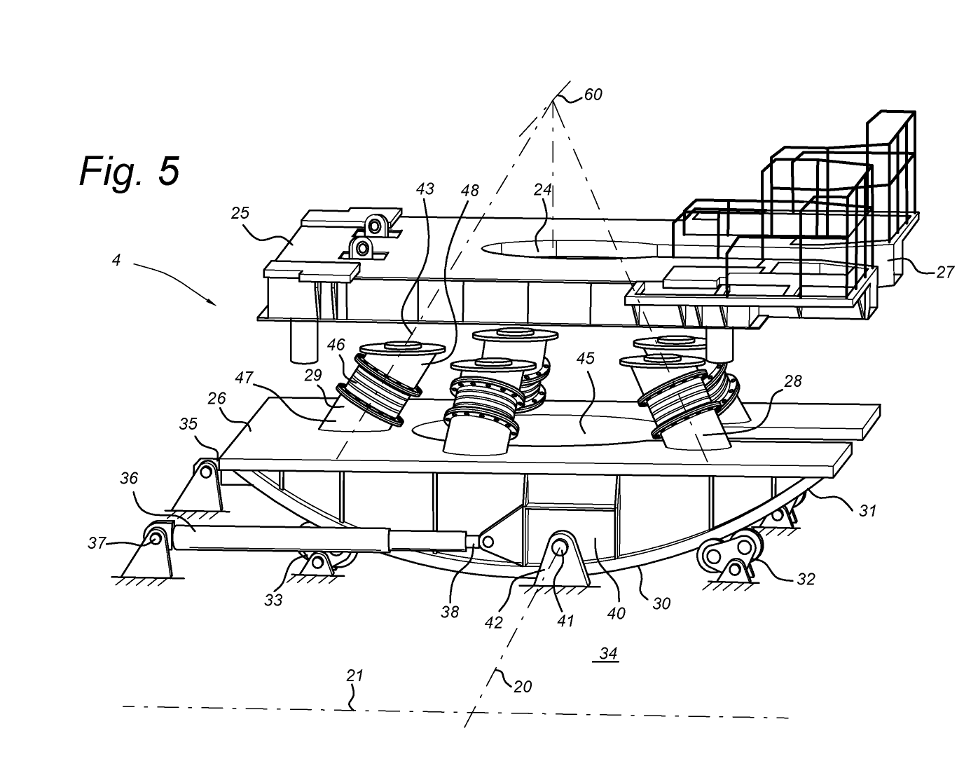

FIG. 6 shows a top view of the work structure 4, showing the relative positions of the curved tracks 31, 32, the four sets of bogie wheels 32,33 at the ends of the tracks 31, 32 and the elastomeric supports 28, 29 distributed around the central openings 24, 45 of the elevating platform 25 and the compensator platform 26. A locking pin or a friction brake 41, 41′ is provided on each side of the platforms 25, 26 and may comprise a remotely controlled cylinder that drives the locking pins into and out of engagement with the flange 40 of the compensator platform. The locking pins 41, 41′ form a backup for the hydraulic cylinders 35,36 and are engaged only in standby and storage conditions. In the operational state, the locking pins 41, 41′ are retracted away from the compensator platform 26.

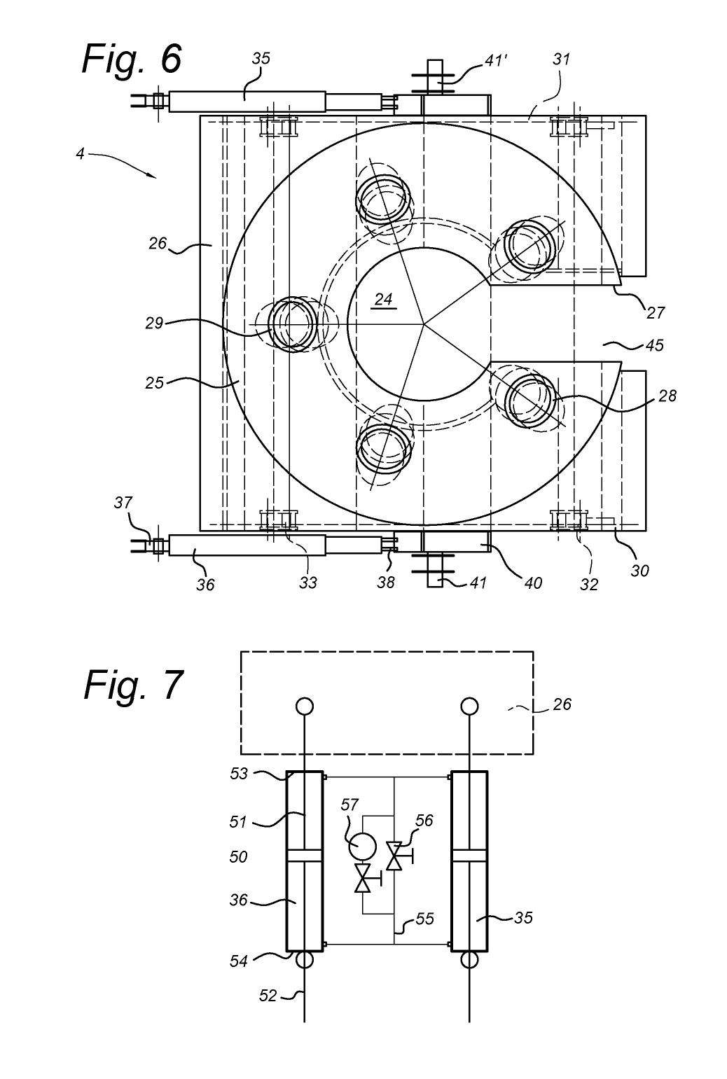

FIG. 7 shows an embodiment wherein the cylinders 35, 36 each comprise a piston 50, a first piston rod 51 on one side of the piston 50 connected to the compensator platform 26 and a second piston rod 52 connected the opposite side of the piston 50 and attached to the deck of the vessel or to the launch platform. The ends 53, 54 of the cylinders 35, 36 are interconnected via a duct 55 and a controllable valve 56. A pressure pump 57 is provided for active control of the cylinders 35, 36.

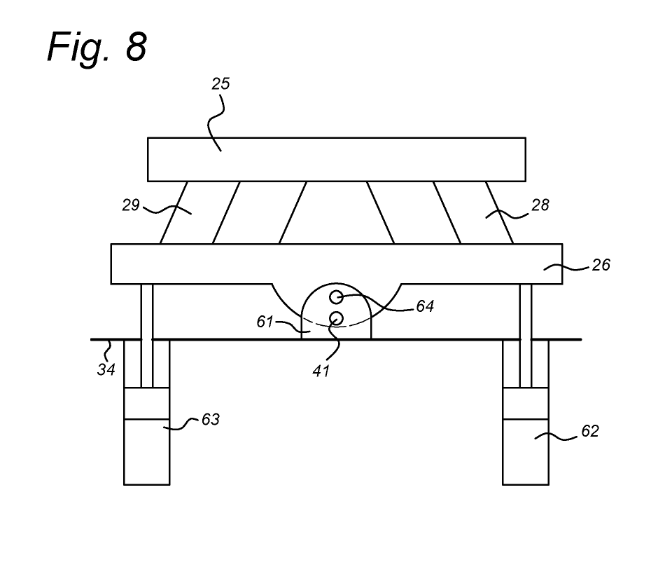

FIG. 8. shows an embodiment wherein the compensator platform 26 is supported in a pair of support brackets 61 via pins 64. The elevating platform 25 is placed on the elastomeric supports 28,29. Vetically arranged hydraulic cylinders 62,63 are connected to the compensator platform 26 for damping of the pivoting movement. A locking pin 41 is provided to lock the position, for instance horizontal, of the compensator platform 26 relative the deck 34. The compensator platform 26 may be formed by an inner and an outer platform that are pivotable about mutually perpendicular axes, similar to the construction of the gimbal table shown in FIG. 2 of US 2010/0119307.

1. Floating structure (1) comprising hull (3) and a work structure (4) for supporting, lifting or lowering elongate objects (5, 16, 17), the work structure comprising an elevating platform (25) having an opening (24) for receiving an object to be supported, lifted or lowered, the elevating platform being supported on the hull (3) and connected to a movable force element (35, 36), wherein, the work structure comprises a compensator platform (26) pivotally supported on the hull around at least one pivot axis (60,64), the compensator platform comprising an opening (45) for receiving the object to be handled, the elevating platform being supported on the compensator platform via at least one elastomeric support (28, 29), the force element (35, 36) being on one side (37) attached to the hull and on the other side (38) to the compensator platform (26) for transmitting a driving force or a damping force to the platform (26) when the platform is pivoted around the pivot axis (60,64).

2. Floating structure according to claim 1, the compensator platform (26) being supported on the hull via at least one curved track (30, 31) that is displaceable relative to the hull (3).

3. Floating structure (1) according to claim 1, wherein the work structure (4) comprises a locking mechanism (40, 41, 41′) for locking the position of the compensator platform (26) around the tilt axis (20) relative to the hull (3).

4. Floating structure (1) according to claim 2, wherein the work structure (4) comprises at least two spaced-apart wheel elements (32, 33) on the hull (34), opposite ends of the curved track (30, 31) of the compensator platform (26) engaging with the wheel elements.

5. Floating structure (1) according to claim 4, wherein the compensator platform (26) comprises two substantially parallel spaced-apart curved tracks (30, 31), each supported on the hull (34) via at least two wheel elements (32, 33).

6. Floating structure (1) according to claim 4, wherein the wheel elements (32, 33) each comprise a set of at least two wheels or bogie.

7. Floating structure (1) according to claim 1, wherein the elevating platform (25) is supported on the compensator platform (26) via at least three elastomeric supports (28, 29), arranged around the openings (24, 45).

8. Floating structure (1) according to claim 7, wherein elastomeric supports (28, 29) are of generally cylindrical shape having longitudinal axes (43) that are at an angle (α) relative to the compensator platform (26) such as to be inclined towards the openings (24, 45).

9. Floating structure (1) according to claim 1, the force element comprising at least two substantially horizontally arranged cylinders engaging with one end (37) on a driving flange (40) on the compensator platform (26).

10. Floating structure (1) according to claim 9, the locking mechanism comprising a movable pin or a friction brake mounted on the hull, that can be engaged with the driving flange.

11. Floating structure (1) according to claim 9, the cylinders (35, 36) each comprising a piston (50), and on each side of the piston a piston rod (51, 52) extending in the cylinder, a bypass duct (55) connecting each side of the cylinder via a valve (56).

12. Floating structure (1) according to claim 1, the work structure (4) projecting beyond a side (9) of the hull (3).

13. Floating structure (1) according to claim 1, the structure comprising a substantially vertical mast (10) situated near the work structure (4) for supporting an elongate structure to be lowered or lifted, and a crane (12) for lowering and lifting the object and for engaging the object with the work structure.

14. Floating structure (1) according to claim 2, wherein the work structure (4) comprises a locking mechanism (40, 41, 41′) for locking the position of the compensator platform (26) around the tilt axis (20) relative to the hull (3).

15. Floating structure (1) according to claim 3, wherein the work structure (4) comprises at least two spaced-apart wheel elements (32, 33) on the hull (34), opposite ends of the curved track (30, 31) of the compensator platform (26) engaging with the wheel elements.

16. Floating structure (1) according to claim 5, wherein the wheel elements (32, 33) each comprise a set of at least two wheels or bogie.

17. Floating structure (1) according to claim 2, wherein the elevating platform (25) is supported on the compensator platform (26) via at least three elastomeric supports (28, 29), arranged around the openings (24, 45).

18. Floating structure (1) according to claim 3, wherein the elevating platform (25) is supported on the compensator platform (26) via at least three elastomeric supports (28, 29), arranged around the openings (24, 45).

19. Floating structure (1) according to claim 4, wherein the elevating platform (25) is supported on the compensator platform (26) via at least three elastomeric supports (28, 29), arranged around the openings (24, 45).

20. Floating structure (1) according to claim 5, wherein the elevating platform (25) is supported on the compensator platform (26) via at least three elastomeric supports (28, 29), arranged around the openings (24, 45).
